(19) United States
(12) Patent Application Publication
(10) Pub. No.: US 2009/0256681 A1
(43) Pub. Date: Oct. 15, 2009

(54) RFID FOLDER LABEL

(75) Inventors: Eric COLLINS, Montgomery Village, MD (US); Hugh ALLEN, Cary, NC (US)

Correspondence Address: LOWE HAUPTMAN HAM & BERNER, LLP, 1700 DIAGONAL ROAD, SUITE 300, ALEXANDRIA, VA, 22314, US

(73) Assignee: VIRTUAL DOXX CORPORATION, Gaithersburg, MD (US)

(21) Appl. No.: 12/421,951

(22) Filed: Apr. 10, 2009

Related U.S. Application Data
(60) Provisional application No. 61/043,856, filed on Apr. 10, 2008.

(51) Int. Cl. H04B 7/00

(52) U.S. Cl. 340/10.1

(57) ABSTRACT

A label having at least one printable face is described. The label comprises a first face having an embedded RFID inlay and a second face which is printable. The second face comprises a dynamically-generated printed region comprising at least one of a variable data field, a variable color coding value, or a variable bar code, each based on user-supplied data.

### RELATED APPLICATIONS

The present application is based on, and claims priority from, Provisional Application No. 61/043,856, filed Apr. 10, 2008, the disclosure of which is hereby incorporated by reference herein in its entirety.

### BACKGROUND

Indexing file folder records is a common practice, with numerous methods employed. File folders are typically indexed on an extended side view or top view tab. In many cases, labels are pulled off of rolls, with a different roll for each alphabetic character, e.g., A-Z, or numeric character, e.g., 0-9, each of which is assigned a unique color. These individual labels are placed on the file folder tab one-at-at-time corresponding to a file name or a file number. In some cases, text fields describing the file folder are hand written on the tab or produced on a typewriter on traditional sheeted label stock, and applied to the tab along with the individual alphabetic or numeric labels. In some cases, a bar code label is also applied to the folder tab or folder body. In any of the described embodiments of file folder indexing, a separate RFID label can be applied, produced on a special RFID printer and applied separately to the file folder. The present inventors are unaware at this time of a system in which all components are included in a single label.

One example prior approach is U.S. patent application Ser. No. 09/874,749, which appears to describe a separate RFID label attached to file folder records, and which does not have a printable surface, and which is applied on the body of the folder and not on the file folder tab which is for purposes of placement of a label with visual index values as used for filing and retrieving file folder records from a file folder storage location.

The current art of associating a RFID label with a file folder record is to encode into the RFID inlay transmitter an index value that is separately defined within a computerized database as a unique identifier for a corresponding file folder record and for which the label is being printed and onto which the label is being applied. The data value is encoded into the RFID inlay/transmitter while the label is being printed on a specialized RFID printer. Standard office printers cannot encode a RFID transmitter and also print variable color-coding, text and bar codes, and therefore the RFID label is a separate entity. Prior approaches for labeling file folder records with two or more labels increases costs, increases the likelihood of human error and can cause file folder records to be lost or misplaced due to inconsistencies between the values relating to the file folder record and the value encoded into the RFID transmitter.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a combined front and rear view of a an RFID label according to an embodiment;

FIG. 2 is a perspective view of a check-in/out device according to an embodiment;

FIG. 3 is a view of a portable RFID scanner in use scanning a file folder having an RFID label according to an embodiment affixed thereto;

FIG. 4 is a perspective view of the check in/out device in use according to an embodiment; and

FIG. 5 is a stylized view of an emplaced RFID scanner scanning a folder according to another embodiment;

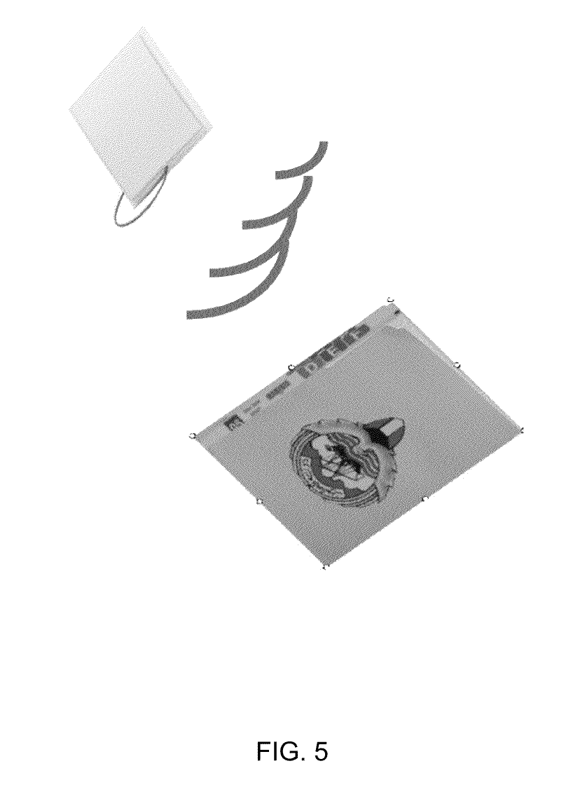

FIG. 6 is a high-level functional block diagram of a processor-based system usable in conjunction with an embodiment; and

FIG. 7 is a high-level process flow diagram of a method of operation according to an embodiment.

### DETAILED DESCRIPTION

One of the objects of at least one embodiment according to the present application is a file folder label combining several elements for improved indexing of file folder records, including variable color-coding, variable text, variable bar code(s) and an RFID inlay, and/or which can be printed on office printers and/or which does not require encoding of a host database record identifying value. Another object in at least some embodiments is the ability to mount the RFID inlay on more frequently used paper sizes, such as used in copiers or printers and which can be printed with variable color-coding, text and/or bar code(s) and/or which may also be glued to file folders using automated or semi-automated machine processes.

Another object of at least one embodiment according to the present application is a device and method for associating a randomly encoded RFID inlay with a database relating to the file folder records and specifically to each file folder receiving a RFID label/inlay, resulting in the random RFID inlay # being added as a data value to the file folder record's corresponding computerized database record, thus enabling the production of a single label encoded with a random and unrelated RFID identification value. Other objects will become apparent to those skilled in the art in light of the following description and drawings.

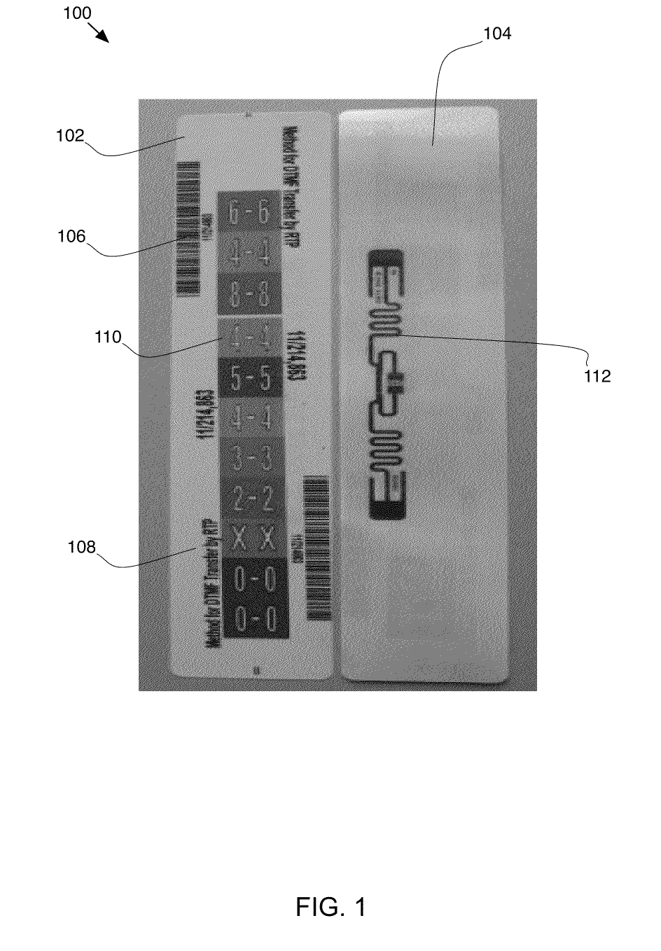

FIG. 1 depicts the front and back of a label 100 according to an embodiment of the present invention comprising a front face 102 and a back face 104. Label 100 is generally rectangular-shaped and arranged so that one face 102, 104 overlaps a portion of a first and second side of a file folder. That is, front face 102 overlays a portion of one side of a file folder and a portion of the opposite side of the file folder in use. An adhesive or other affixing mechanism may be used to apply label 100 to the file folder. In at least one embodiment, an adhesive is applied to back face 104.

Front face 102 is arranged to incorporate, in at least one embodiment, a bar code region 106, a textual information region 108, and a dynamically generated color-coding region 110. In accordance with at least one embodiment, either or both of bar code region 106 and textual information region 108 may be dynamically generated. In at least some embodiments, the bar code region 106 and/or the textual information region 108 are printed after application of RFID inlay 112 to label 100. In at least some embodiments, the bar code region 106 and/or the textual information region 108 are printed just prior to application of label 100 to a file folder.

Back face 104 is arranged to incorporate an RFID inlay 112 on or in the surface of the label.

In a first embodiment of the invention, label 100 includes embedding or attaching RFID inlay ‘signal receiver’ 112 on a substrate material with adhesive undercoating over the antenna/receiver, and a release layer underneath the antenna forming the die-cut sheet itself. Sheeted labels produced for printing on ink jet and/or laser printers can be used. In at least one embodiment, 60# matte coated ink jet label material is used, which can be used with either ink jet or laser printers, 4.5 mils caliper, optimized for water resistant ink-on-sheet properties; a tackified, Acrylic Emulsion, general purpose permanent adhesive with excellent adhesion to many substrates including glass, steel and paper; and a 54# coated one side kraft liner, 3.2 mils. Sheets of labels may be die cut 6-up with 8″×1.5″ label die cuts; however, any number of die cuts/labels and label sizes can be on the sheet, and the sheet margins there-around can be printed with graphics and text to identify and brand the product.

Different RFID inlays 112 may be used in accordance with different embodiments. In at least one embodiment, RFID inlay 112 is based on an ultra high frequency (UHF) RFID integrated circuit (IC) antenna design, e.g., similar to the Alien Technology model ALN-9540 Squiggle Inlay, with EPC Gen 2 range, and compliant with international RFID Sensitivity & Orientation and frequency standards of 860-960 Mhz, and of an overall size of approximately 8.15 mm×94.8 mm×0.3 mm.

In accordance with at least one embodiment of the label, the label comprises a sheet of die-cut adhesive labels with each die cut area (label) nominally 8″×1.5″ and which includes an RFID inlay 112 sandwiched between the adhesive layer and the label sheet release layer and the sheets printable on ink jet or laser color printers for printing variable text, color code designators and/or bar code(s). The labels can subsequently be removed from the label sheet and applied to file folder records, thus combining the key elements of Records Management into a single label that indexes the file folder records with RFID inlay identifying information, bar code identification, color identification and human readable text values. Whereas desktop ink jet and/or laser printers do not exist today that enable labels to be printed with variable color-coding and the RFID inlay encoded while being printed, it is envisioned that over time the described label invention will be printable and the RFID encoded during the printing process producing labels with text, bar code(s) and color-coding and with the RFID inlay encoded with a corresponding file folder record index value. Those skilled in the art will see many other potential embodiments, including future iterations of ink jet, laser and thermal color printers able to produce all noted elements of a file folder label, and that may also be able to simultaneously encode the RFID inlay at the time of printing, and any of many ways to produce labels on roll or label stock.

FIG. 1 depicts a front and back view of label 100 according to one embodiment in which the label is peeled-off of a sheet comprising more than one label. The label is 8 inches×1.5 inches, and there are typically six (6) such sized labels die cut within an 8.5″×11″ sheet, each label with a printable area on each label's top outside surface, a RFID inlay tag 112 underneath (on the backside or back face 104) of the printable surface and having adhesive covering the RFID inlay and mounted on a release liner of the sheet. Whereas approximately 8″×1.5″ is one size for file folder labels, the labels can be many other sizes depending on the item onto which they will be placed and the type of RFID inlay 112 used. The label outside/top surface or front face 102 in FIG. 1 depicts one method of printing records management indexes on a file folder label 100, and in this example shows the dynamically generated color coding region 110 color-coding a variable client/matter number, bar code region 106 keyed to an Application Serial Number, and text regions 108 for the Application Serial Number and Application Title. Label surfaces 102, 104 may be printed with any color, bar code and text fields desired by a user based on particular records management requirements.

FIG. 1 depicts a particular RFID receiver/inlay 112; however, in differing embodiments many variations of RFID inlays may be built into label 100. RFID inlay 112 comprises a transponder, a memory and an antenna for interrogation by RFID readers and/or encoding by RFID readers and/or printers. In response to being interrogated, inlay 112 transmits data stored in memory, such as RFID tag identifying information, to an RFID Reader via the antenna. Each RFID inlay 112 read by a reader causes, in at least some embodiments, an update of record management information, typically to commission a RFID tag corresponding to the read RFID inlay 112 in a database and/or to transfer the record(s) to new location(s), based on underlying software logic. By integrating the RFID inlay 112 and surface printing of optically and bar code readable fields in one label, an improvement over the current approaches requiring two (2) or more labels to accomplish the same functionality is obtained.

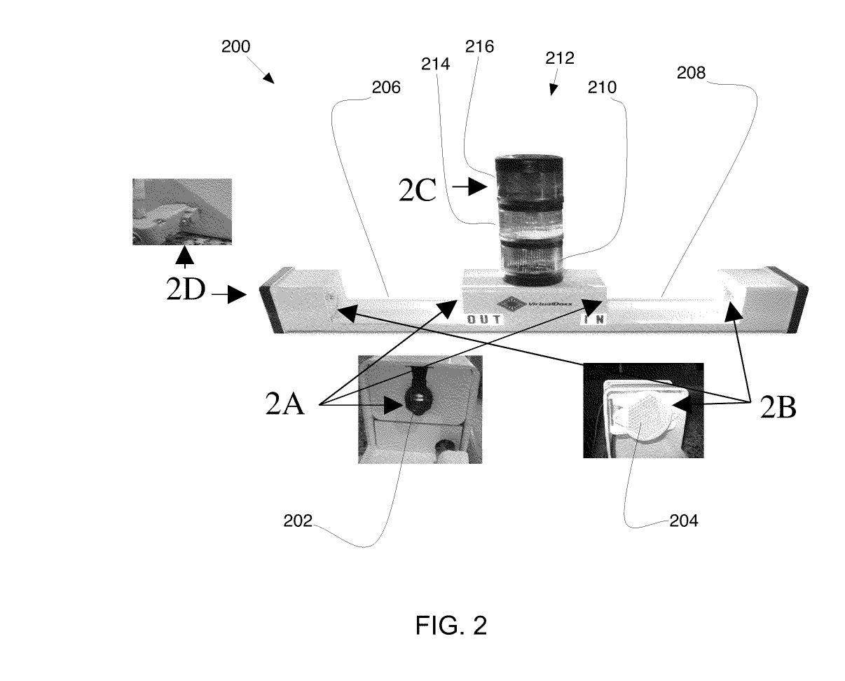

FIG. 2 depicts a device, i.e., RFID controller 200, enabling the RFID identifying information encoded in RFID inlay 112 during the original manufacturing process prior to being provided to a label converter for embedding within a label 100 to be commissioned to an underlying computerized database and linked to other record-level data elements in the database and which are associated with the corresponding file folder record and which, or a subset thereof, are printed on the file folder label as index values. The RFID controller 200 comprises photo eye(s) 202 and reflector(s) 204 such that the photoeye continuously emits an infrared beam toward the reflector opposite the photo eye within either an In slot 206 or an Out slot 208 on the RFID controller. As a result of the infrared beam between the photo eye and reflector being broken an RFID reader and/or antenna is activated, which is visually confirmed by a green area 210 on the integrated light-pole 212 illuminating.

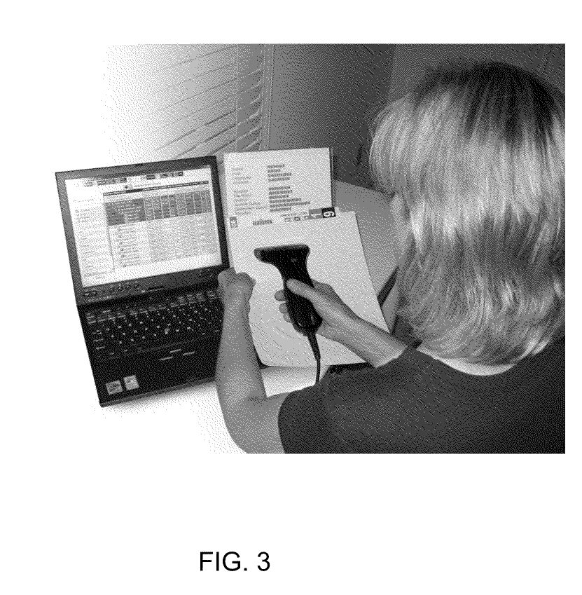

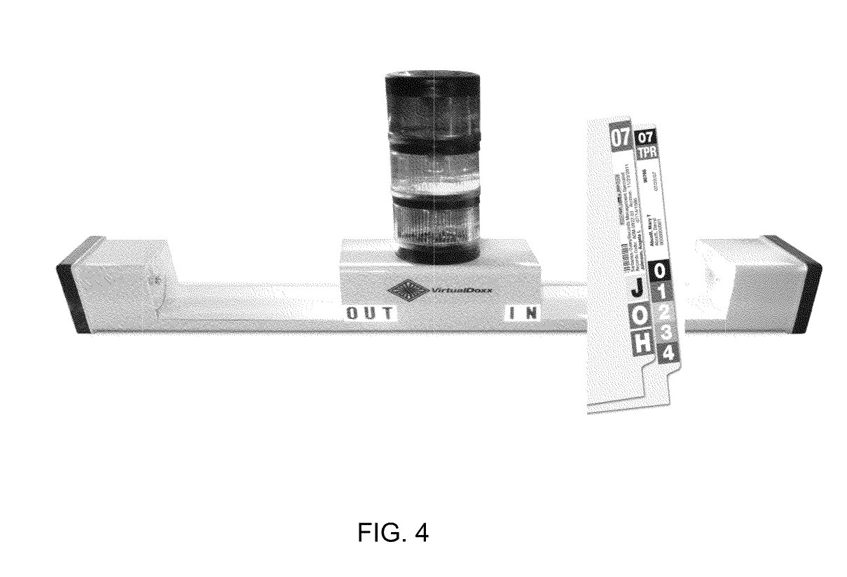

Upon activating, the RFID antenna stays powered for a predetermined time period, e.g., a particular number of seconds as defined in a setup, e.g., a software setup, of RFID controller 200, and reads RFID tags within range of the antenna, and which for commissioning represents a single record. The RFID antenna's power (attenuation) can be increased or decreased to ensure that only the record to be commissioned which is in close proximity to the RFID antenna is read. The first step of the commissioning method, depicted visually in FIG. 3, is to read the bar code on the file folder label, or to enter a file folder unique identifier by a keyboard into a designated data entry portion of the records management software, e.g., by causing RFID controller 200 to read an RFID inlay 112 on a folder as depicted in FIG. 4, and the records management software performs a lookup of key values from the database corresponding to the bar code identifying information that was read and which is a unique identifier within the database and displays them under the RFID inlay identifying information portion of the data entry blocks on the software commissioning screen so that the User is able to verify that the RFID inlay identifying information is being commissioned to the correct physical file folder record.

The second step of the commissioning method is to break the infrared beam that is projecting from the photoeye(s) built into the device, which turns on the RFID reader/antenna comprising a part of RFID controller 200 and which causes the RFID controller to read the RFID identifying information within the label attached to the file folder record being commissioned.

The third step of the commissioning method occurs once the RFID reader/antenna is activated for a predetermined time period, e.g., a number of seconds, and reads the RFID inlay 112 on the folder within proximity of the controller. Reading of the RFID inlay 112 on the folder is validated by the lights within the yellow and red encasements 214, 216, respectively, of the integrated light-pole 212 illuminating which affirms that the RFID inlay has been read by the activated RFID reader/antenna.

The fourth step of the commissioning method is activation of an RFID Import button titled ‘Get Fixed Scans’ within the integrated records management software that when selected displays the RFID identifying information on the computer screen next to the bar code or unique folder identifier that was previously entered (FIG. 4).

The fifth step of the commissioning method is a button titled ‘Finish Scanning’ on the software screen which uploads the RFID identifying information to the database for the file folder record being commissioned. In accordance with at least one embodiment, the RFID controller 200 activates the RFID reader/antenna on-demand and only for the predetermined time period, whereas prior approaches in RFID Records Management Systems leave the RFID reader/antenna on at all times, which causes excessive radiation to emit which is damaging to the human beings in proximity to the reader/antenna.

Numerous variations in the construction and method of the commissioning device will occur to those skilled in the art in light of this disclosure. For example, there could be other methods, such as buttons, software prompts or the like for turning on the RFID antenna, and there could be different methods of sound or light or computer prompts that indicate that the antenna has turned on, and there are many potential methods within software to actualize the record identification and RFID inlay association (commissioning) process and are further embodiments of the claims herein. An aspect of this invention is the flexibility of the RFID Controller to be built using a wide variety of parts that will produce the same results as described, for example, different types of light-poles and different voltage settings, different methods of turning-on the RFID antenna, a wide variety of RFID readers and/or antennas and/or single unit reader/antennas and the like. Whereas FIG. 2 depicts the preferred embodiment of the RFID In/Out Controller and Commissioning Device, there are many potential and obvious iterations of the device.

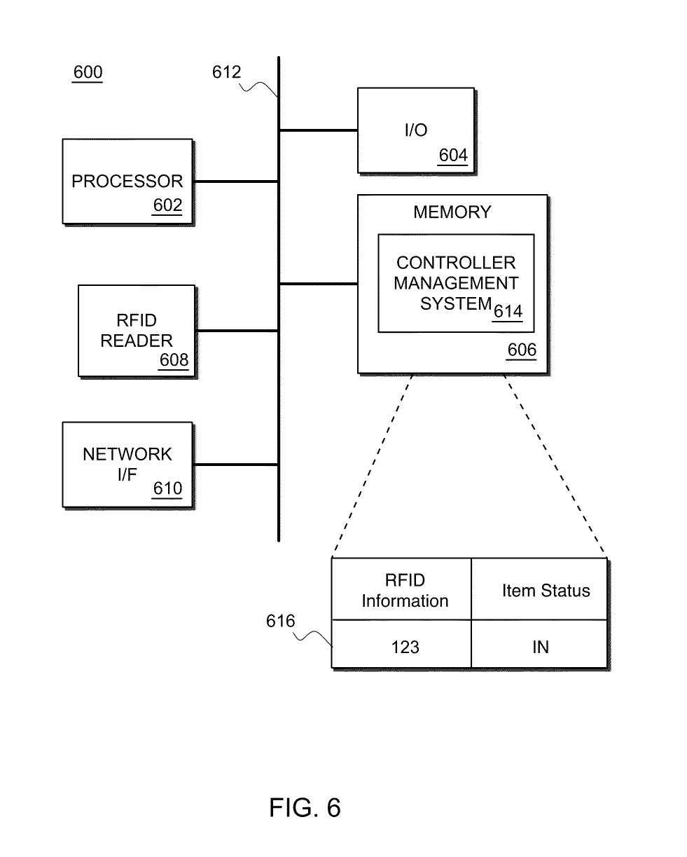

FIG. 6 depicts a high-level block diagram of an RFID controller system 600 in accordance with an embodiment. RFID controller 200 may be implemented as a particular embodiment of RFID controller system 600.

Controller system 600 comprises a processor 602, an input/output (I/O) device 604, a memory 606, an RFID reader 608, and a network interface (I/F) 610 each communicatively coupled via a bus 612 or other interconnection communication mechanism.

Processor 602 may comprise a processor, a microprocessor, a controller, or other device such as an application-specific integrated circuit (ASIC) arranged to execute and/or interpret one or more sets of instructions, e.g., a controller management system 614 stored in memory 606.

Input/output device 604 may comprise an input device, an output device, and/or a combined input/output device for enabling user interaction. An input device may comprise a mechanism for communicating at least a command to processor 602. In at least one embodiment, input/output device 604 comprises the above-described photo eye 202 in combination with detector 204. In operation, responsive to a determination that the infrared beam transmitted between photo eye 202 to detector 204 has been interrupted, input/output device 604 (comprising the photo eye and detector) transmits a signal indicating interruption of the infrared beam. In at least some embodiments, input/output device 604 may comprise a serial and/or parallel connection mechanism. In at least some further embodiments, input/output device 604 may be directly connected to RFID reader 608.

In at least one embodiment depicted in FIG. 2, input/output device 604 comprises two sets of photo eye and detector combinations. In accordance with this embodiment, one set of a photo eye and detector combination is arranged to detect when an item is being checked in, i.e. when an item is being passed through opening 206 (FIG. 2), and another set of a photo eye and detector combination is arranged to detect when an item is being checked out, i.e., when an item is being passed through opening 208. Thus, an item passing through opening 208 causes input/output device 604 to generate a status signal indicative of the item being checked in whereas if the item passes through opening 206 the input/output device 604 generates a status signal indicative of the item being checked out.

In this manner, a predetermined location may be assigned to the check-in and/or check-out of a particular item passing through openings 206, 208. That is as an example, an item being checked in via opening 206 has a corresponding record in a data store updated to reflect that the item is at the predetermined location. A similar arrangement may be used for a particular predetermined check-out location. In at least some embodiments, there may be a predetermined check-in location and/or a predetermined check-out location.

In at least some other embodiments, different mechanisms may be used to indicate the check-in/checkout status of an item. For example, a single set of photo eye and detector combination in conjunction with a toggle switch or button may be implemented in order that the position of the switch determines the check-in/checkout status of the item scanned.

Memory 606 (also referred to as a computer-readable medium) may comprise a random access memory or other dynamic storage device, communicatively coupled to bus 612 for storing data and/or instructions for execution by processor 602. Memory 606 also may be used for storing temporary variables or other intermediate information during execution of instructions to be executed by processor 602. Memory 606 may also comprise a read-only memory or other static storage device coupled to the bus 612 for storing static information and instructions for processor 602.

Memory 606 stores a controller management system 614 (a set of executable instructions) for controlling interaction between RFID reader 608, one or more items to be checked in or checked out, and a record management system. In at least some embodiments, an item to be checked in or checked out may be a file, a folder, a document, or other item having an RFID inlay. And at least some embodiments, memory 606 may also store in a temporary manner information obtained via RFID reader 608 from a scanned item, e.g., scanned RFID information. For example, memory 606 comprises a scanned item status record 616 comprising RFID information received from RFID reader 608 and item status information received from I/O device 604.

RFID reader 608 comprises a transceiver and an antenna for querying and receiving a response from an RFID inlay on an item. Responsive to receipt of RFID information from an RFID inlay on an item, RFID reader transmits a signal indicative of the read information to processor 602.

Network interface 610 comprises a mechanism for connecting to a network. In at least some embodiments, network interface 610 may comprise a wired and/or wireless connection mechanism.

RFID Controller 200 includes two (2) openings each with a photoeye 202 and reflector 204 opposite one another. Operation of RFID controller 200 enables a user to check in or check out a particular file or folder, i.e., cause an indication of ownership and/or location corresponding to the particular file or folder to be changed. In at least some embodiments, RFID controller 200 operates to check in or out the particular file or folder without being directly connected to a computer system. In at least some embodiments, RFID controller 200 operates automatically and independent of a record management system and without requiring user manipulation of a computer to check in or out the particular items read by the RFID reader. In at least some embodiments, based on a default location being established, i.e., specified by the user and recorded by the system, and stored in memory, RFID controller 200 causes the status of a particular item as ‘In’ or ‘Out’ to be modified in the memory of the storage.

When the infrared beam from photo eye 202 to reflector 204 is broken in one of the corresponding In or Out openings 206, 208, the RFID reader, which comprises an antenna element, turns on and reads file folder records, i.e., RFID inlays on items, within the reader read-range. If the In beam was broken, i.e., if an item is placed in the in opening 208, the records are checked in to the repository associated with the location which is programmatically defined in the integrated Records Management software. For example, ‘file room’ or ‘filing system’ or one of a number of other locations within a facility and if the Out slot beam is broken, the RFID Controller which is network connected (FIG. 2D) sends a message to the computer Server which is hosting the Records Management system which performs a database lookup to determine if the record being checked-out had been Requested by a User, i.e., a requester. If the record had been requested, then the record is automatically checked-out to that requester and that record is automatically deleted from the request queue that is a part of the Records Management system. If there is no requester, the record is checked-out to a global ‘Out’ location to indicate that the record has been removed from the repository.

In at least some additional embodiments, a name card or name badge with RFID inlay associated with a location or person can be placed with the folder or stack of folders to transfer associated record(s) to a particular person/location. In at least this embodiment, RFID controller 200 reads the RFID inlay of the name badge along with the RFID inlay of the item and updates the status of the item based on the read information from the name badge. The RFID Controller according to an embodiment improves upon prior approaches in at least some embodiments by enabling connection to the network, without need of a local computer system.

In at least some embodiments, RFID Controller RFID tag (inlay) reads are automatically transmitted to the Records Management system Internet-hosted Server, or a User's Server. In/Out/Location processing is automated and passive without a user interacting directly with the records management system. In at least one embodiment, RFID controller comprises a LED or light bulb/light pole with color exteriors of red, yellow and green. When the photo-eye beam is broken, the red or any of the light(s) are caused to illuminate. The RFID Antenna is activated and reads folders/items within read-range. After the RFID controller reads one or more RFID tags, the yellow and green colors are illuminated. In at least some embodiments, the approach improves upon prior approaches of having to look at computer screens real-time or view anecdotal data to know that RFID reads were successfully captured by the Records Management system. In at least some other embodiments, different notification mechanisms may be used to indicate reading of RFID tags, such as sound alerts based on business rules, such as “person taking record is unauthorized, turn red light on and turn on siren sound on computer for ‘x’ seconds”.

In accordance with another embodiment, RFID Controller is distributed throughout a facility at key ‘choke points’ and these choke points are defined in the underlying Records Management system as ‘locations’, and records arriving at that particular RFID controller (location) will be transferred programmatically within the database to each such location. As such, distributed RFID Controllers establish physical ‘choke points’ throughout a facility(s). The distributed RFID Controllers may have only In directionality and/or both In and Out directionality to track incoming and/or outgoing file folders to that location, with the end result being that the Records Management system knows where each Record is located based on the most recent RFID read and each such read is logged to the underlying Audit Log for chain-of-custody tracking within the database of each such event related to each record.

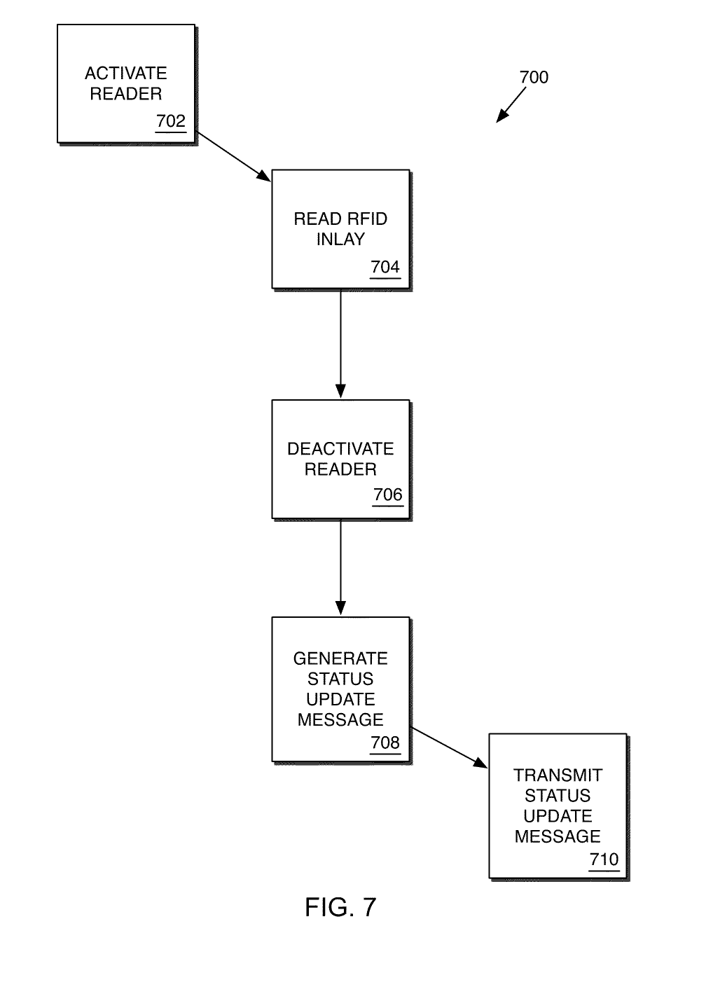

FIG. 7 depicts a high-level process flow diagram of a scanning operation 700 of RFID control or 600 according to an embodiment. The process flow begins at activate reader functionality 702. During execution of the set of instructions comprising activate reader functionality 702 by processor 602, RFID reader 608 receives an activation signal, e.g., an activation signal from input/output device 604, causing the reader to activate the antenna. The process flow proceeds to read RFID inlay functionality 704.

Execution of the set of instructions comprising functionality 704 causes RFID reader 608 to transmit a signal to RFID inlay 112 and receive a response from the inlay. The received response comprises RFID information specific to RFID inlay 112. In at least some embodiments, RFID information received is unique to the particular RFID inlay. The flow then proceeds to deactivate reader functionality 706. In at least some embodiments, after reading RFID information processor 602 stores the read RFID information in memory 606, e.g., in a scanned item record.

During execution of deactivate reader functionality 706, a predetermined period of time is allowed to lapse, e.g., either by RFID reader 608 or processor 602, after which if no further RFID information is read the RFID reader is deactivated. The flow then proceeds to a generate message functionality 708.

Execution of the set of instructions comprising functionality 708 causes processor 602 to generate a message comprising read RFID information from RFID inlay 112 (in at least some embodiments, the RFID information is stored in memory 606) and item status information from input/output device 604 (in at least some embodiments, the item status information is also stored in memory 606). The flow then proceeds to transmit functionality 710.

During execution of transmit functionality 710, execution of the set of instructions by processor 602 causes the processor to transmit the generated message via network interface 610. In at least some embodiments, transmit functionality 710 causes the processor to transmit the generated message to a computer system, a server, or other device configured to receive the message, e.g., a portable digital assistant, a handheld communication device such as a cellular telephone, etc.

Upon reception of the transmitted message, the server performs a lookup of the RFID information in the message to determine the corresponding item to which the status information relates. The server then updates the status information in a record management system based on status information in the message.

In at least some embodiments, the present system may be equally used for tracking any item of any kind, such as inventory, tools, parts, weapons, evidence, assets, people, specimens, test tubes, products, packages, mail, documents, food or any similar item, and that these items are indexed with a wide variety of label materials, sizes and construction and include a wide variety of RFID inlays of different technologies and frequencies and which are produced at a factory and/or with any variety of printing device.

In at least a further embodiment, the Records Management system is hosted at a remote site and RFID reads are transmitted from the locale of the RFID reader to the remote Computer Server and then Users at the locale have near real-time event updates within their Records Management system application viewed within the Records Management system on the User's computer.

In at least one embodiment, RFID controller 200 transforms the read data of the RFID inlay of an item in combination with one or more locations and/or identities into stored information regarding the status of the item, e.g., a scanned item status record 616. In at least some embodiments, the scanned item status record 616 corresponds to a representation of the physical item status.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A label having at least one printable face comprising:
a first face having an embedded RFID inlay, and;
a second face which is printable and comprising a dynamically-generated printed region comprising at least one of a variable data field, a variable color coding value, or a variable bar code, each based on user-supplied data.

2. The label as claimed in claim 1, wherein the first face comprises an adhesive layer covering at least a portion of the first face.

3. The label as claimed in claim 1, wherein the dynamically-generated printed region encodes at least a portion of the user-supplied data.

4. The label as claimed in claim 1, wherein the dynamically-generated printed region includes at least a portion of user-supplied data in a user-readable form.

5. The label as claimed in claim 1, wherein the RFID inlay is positioned entirely on one half of the first face.

6. The label as claimed in claim 1, wherein the dynamically-generated printed region comprises the variable color coding value positioned straddling a centerline of the second face.

7. The label as claimed in claim 1, wherein the label is die cut on label sheets printable on at least one of an ink jet printer, a laser printer, or a thermal printer.

8. The label as claimed in claim 1, wherein the label comprises a cellulose-based material.

9. The label as claimed in claim 8, wherein the label is sized for application on a file folder.

10. A controller-based record management system comprising:
a controller arranged to execute one or more sets of instructions;
an RFID reader arranged to communicate with the controller; and
a memory communicatively coupled with the controller and storing a set of instructions which, when executed by the controller, causes the controller to:
read, using the RFID reader, an RFID inlay affixed to an item;
generate an item status update message indicative of a status change of the item and including at least a portion of the information read by the RFID reader; and
transmit the item status update message to a server for storage.

11. The system as claimed in claim 10, wherein the item status update message comprises read RFID information and item status information.

12. The system as claimed in claim 10, further comprising an input device communicatively coupled with the RFID reader and comprising:
a photo eye; and
a detector positioned to detect an infrared beam transmitted by the photo eye.

13. The system as claimed in claim 12, wherein the input device is arranged to transmit a signal indicative of the detector not detecting the infrared beam.

14. The system as claimed in claim 13, wherein the RFID reader is arranged to read an RFID inlay responsive to the input device transmitting the signal indicative of the detector not detecting the infrared beam.

15. The system as claimed in claim 12, further comprising an other input device communicatively coupled with the RFID reader and comprising:
an other photo eye; and
an other detector positioned to detect an infrared beam transmitted by the photo eye.

16. The system as claimed in claim 15, wherein the input device is arranged to transmit a check in signal indicative of the detector not detecting the infrared beam.

17. The system as claimed in claim 15, wherein the input device is arranged to transmit a check in signal indicative of the detector not detecting the infrared beam and the other input device is arranged to transmit a check out signal indicative of the detector not detecting the infrared beam.

18. The system as claimed in claim 15, wherein the item status update message content corresponds to the input device or the other input device not detecting infrared beam.
